(19) United States
(12) Patent Application Publication
(10) Pub. No.: US 2006/0081276 A1
(43) Pub. Date: Apr. 20, 2006

(54) Assembled umbrella shank

(76) Inventor: Benson Tung, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 10/967,175

(22) Filed: Oct. 19, 2004

(51) Int. Cl. A45B 3/00; G09F 15/00

(52) U.S. Cl. 135/16; 40/607.02; 135/25.4

(57) ABSTRACT

An assembled umbrella shank includes a hollow cylindrical core having multiple holes longitudinally defined in an outer periphery of the cylindrical core, multiple first pieces each having multiple first hooks formed on opposite sides of the first piece to correspond to and extend into the holes of the cylindrical core, and multiple second pieces each having multiple second hooks formed on opposite sides of the second piece to correspond to and extend into the holes of the cylindrical core such that after the first pieces and the second pieces are assembled on the outer periphery of the cylindrical core, an annular periphery of the cylindrical core is enclosed.

### BACKGROUND OF THE INVENTION

1. Field of the Invention

The present invention relates to an umbrella shank, and more particularly to an assembled umbrella shank.

2. Description of Related Art

The current umbrella is composed of a shank, a nest slidably mounted on the shank, multiple ribs divergently extending from a distal end of the shank, multiple secondary ribs each having a first end spatially spaced apart from one another and extending from a point of the nest and a second end securely connected to a side face of a corresponding one of the ribs, and a canopy evenly spread on and supported by the ribs. Therefore, the sliding movement of the nest on the shank is able to extend the canopy. This umbrella has a major drawback. That is, the shank is made of a metal so that during normal use, i.e, on rainy days, the umbrella user may have a high risk of receiving an electric shock via lightning. Furthermore, the sliding movement of the nest somewhat removes a plated surface of the shank, which destroys the overall appearance of the umbrella.

In order to avoid such a fatal risk, a new shank made of composite material is developed to the market. The new shank has a core made of carbon fiber and an outer layer enclosing the core. The outer layer is made of wood. Due to the material of the outer layer, the new shank virtually eliminates the chance of an electric shock via lightning strike to the umbrella user. However, serious shortcomings shorten the life span of this new design.

1. High Manufacture Cost:

In order to make the core, multiple heating and pressing processes are involved to allow a carbon fiber to become the core. Then a wooden outer layer is attached to an outer periphery of the core. Thus too much labor and time are required to make this new design.

2. High Material Cost

Because the conventional manufacturing equipment for making the conventional umbrella shank is not suitable for making this new design, the conventional equipment is wasted and new equipment has to be purchased, which has a negatively influence to the eventual price of such a product.

3. Low Appearance Variation

After the wooden outer layer is attached to the core, there is not much room left for modification to the appearance of the wooden outer layer and thus the wooden outer layer is dull.

To overcome the shortcomings, the present invention tends to provide an improved assembled umbrella shank to mitigate the aforementioned problems.

### SUMMARY OF THE INVENTION

The primary objective of the present invention is to provide an improved assembled umbrella shank to increase diversities of the appearance of the shank.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the assembled umbrella shank of the present invention;

FIG. 2 is a perspective view of the umbrella shank in FIG. 1 in assembly;

FIG. 3 is a cross sectional view showing the engagement of the covering pieces to the core;

FIG. 4 is an exploded perspective view of the assembled umbrella shank of the present invention;

FIG. 5 is a cross sectional view showing the engagement between the first covering piece and the second covering piece in FIG. 4;

FIG. 6 is a cross sectional view showing that the first piece has multiple pairs of hooks and the second piece has multiple pairs of recesses corresponding to the first hooks;

FIG. 7 is a cross sectional view showing that the core has a pair of opposed grooves defined in an outer periphery of the core; and

FIGS. 8 and 9 are schematic side plan views showing that the shank has different appearance choices.

### DETAILED DESCRIPTION OF THE PREFERRED EMBODIMENT

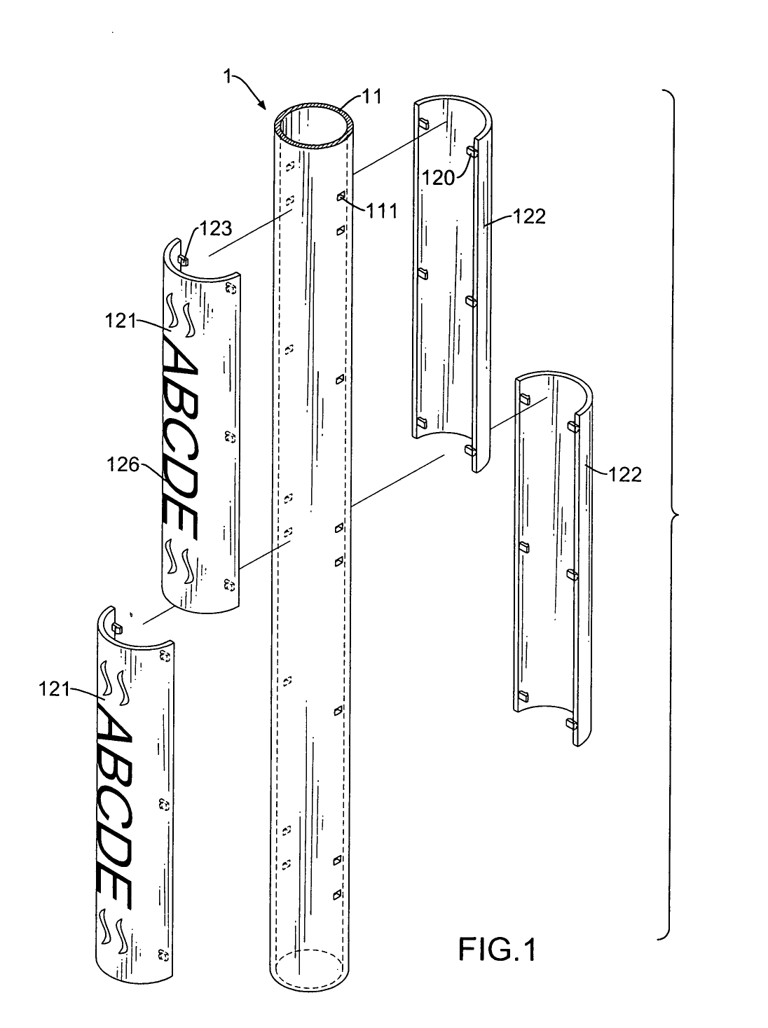

With reference to FIG. 1, the umbrella shank (1) in accordance with the present invention includes a hollow cylindrical core (11) made of a metal material and multiple first pieces (121) and multiple second pieces (122) connected to the first pieces (121) to enclose an outer periphery of the cylindrical core (11).

The cylindrical core (11) has multiple holes (111) longitudinally defined through the outer periphery of the cylindrical core (11). Each first piece (121) includes multiple first hooks (123) and each second piece (122) includes multiple second hooks (120). Each first hook (123) and second hook (120) correspond to one of the multiple holes (111) of the cylindrical core (11).

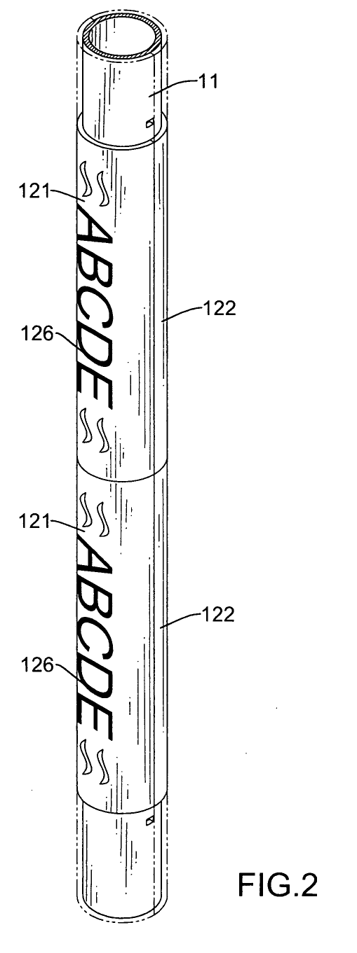

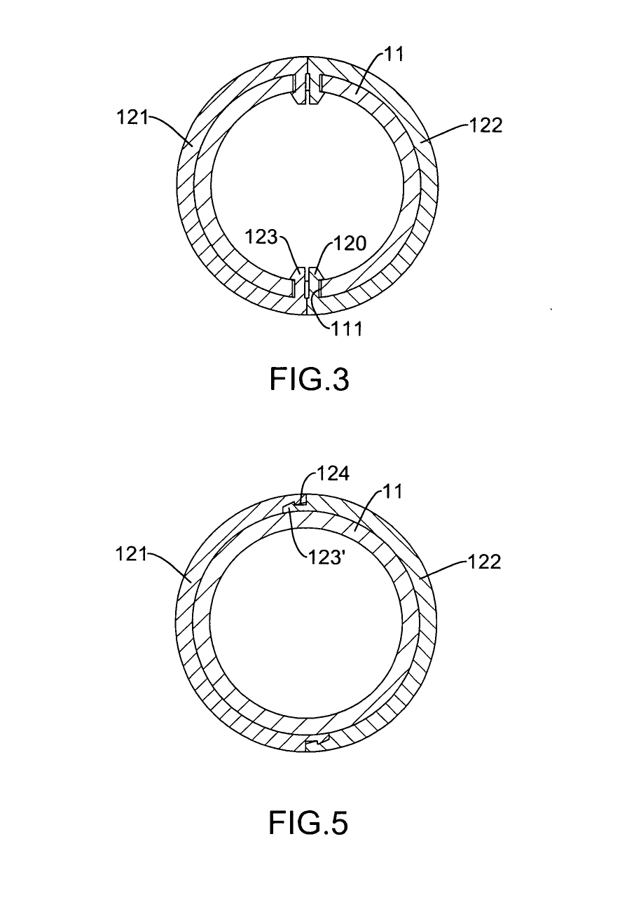

With reference to FIGS. 2 and 3, it is to be noted that when the first pieces (121) are assembled on the outer periphery of the cylindrical core (11), the first hooks (123) are inserted into the corresponding holes (111). When the second pieces (122) are assembled on the outer periphery of the cylindrical core (11), the second hooks (120) are inserted into the corresponding holes (111). After one of the first pieces (121) and one of the second pieces (122) are assembled on the outer periphery of the cylindrical core (11), an annular periphery of the cylindrical core (11) is enclosed by the combination of one first piece (121) and one second piece (122). It is to be noted in this embodiment, there are multiple first pieces (121) and multiple second pieces (122). However, the first pieces (121) can be integrally formed into one piece and the second pieces (122) can be integrally formed into one piece as well such that the overall periphery of the cylindrical core (11) may be enclosed by one first piece (121) and one second piece (122). Furthermore, an outer periphery of both the first piece (121) and the second piece (122) is provided with a pattern (126) which may be characters, words, or drawings to increase the overall attraction of the shank (1) of the present invention.

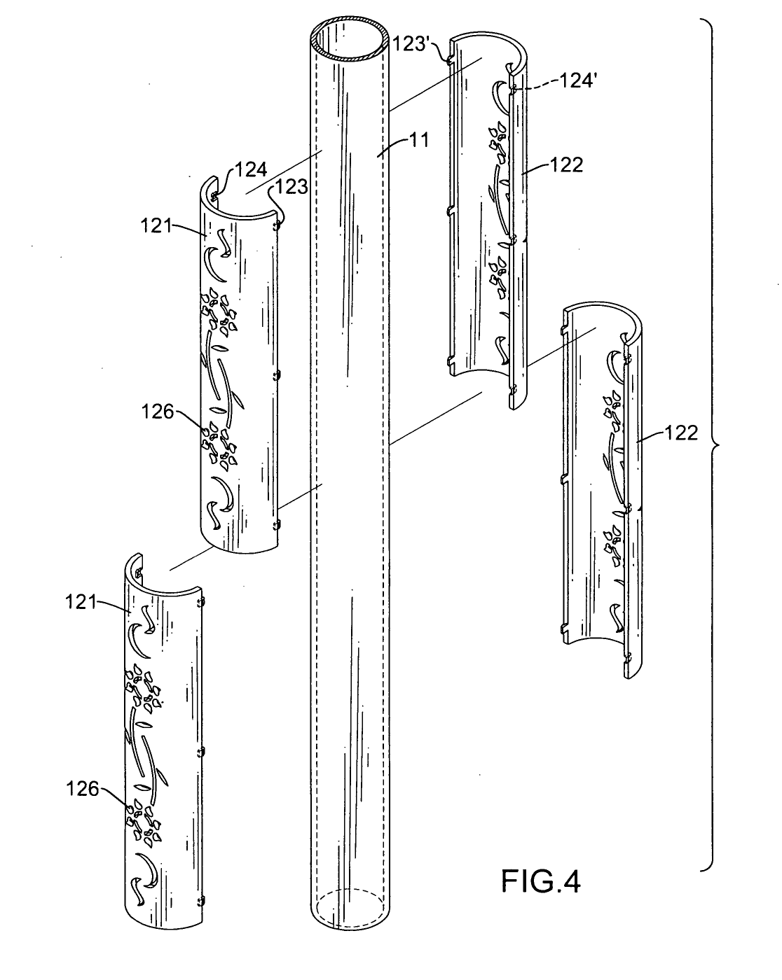

With reference to FIGS. 4 and 5, it is noted that the first piece (121) is provided with multiple first hooks (123) radially extending out from one side of the first piece (121) and multiple first recesses (124) defined in the other side of the first piece (121). The second piece (122) has multiple second hooks (123′) radially extending out from one side of the second piece (122) to correspond to the multiple first recesses (124) and multiple second recesses (124′) radially defined in the other side of the second piece (122) to correspond to the multiple first hooks (123). When the first pieces (121) and the second pieces (122) are assembled, the first hooks (123) are inserted into the corresponding second recesses (124′) and the second hooks (123′) are inserted into the corresponding first recesses (124) such that one first piece (121) and one second piece (122) are able to enclose an annular periphery of the cylindrical core (11). Each first piece (121) and second piece (122) are also provided with a pattern (126) on an outer periphery of the first piece (121) and the second piece (122) in this embodiment.

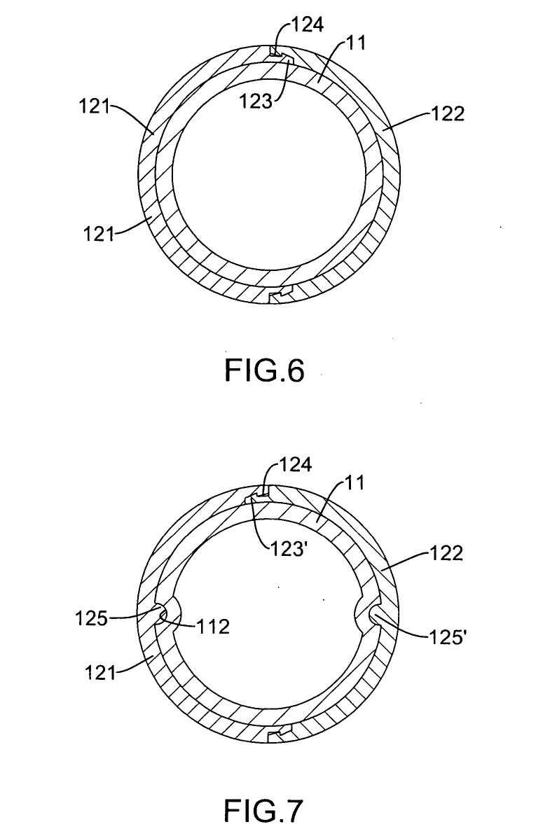

Besides, as shown in FIG. 6, it is noted that a different embodiment of the present invention shows that the first piece (121) has multiple pairs of hooks (123) and the second piece (122) has multiple pairs of recesses (124) corresponding to the hooks (123) such that after the hooks (123) are inserted into the corresponding recesses (124), the first piece (121) and the second piece (122) are securely engaged with one another.

With reference to FIG. 7, furthermore, in order to enhance the engagement among the cylindrical core (11), the first pieces (121) and the second pieces (122), the cylindrical core (11) is provided with a pair of opposed recesses (112) longitudinally defined in an outer periphery of the cylindrical core (11). The first piece (121) is provided with a first boss (125) longitudinally formed on an outer periphery of the first piece (121) and the second piece (122) is also provided with a second boss (125′) longitudinally formed on an outer periphery of the second piece (122). Therefore, after the first boss (125) and the second boss (125′) are received in the opposed recesses (112) of the cylindrical core (11), the engagement among the cylindrical core (11), the first piece (121) and the second piece (122) is strengthened.

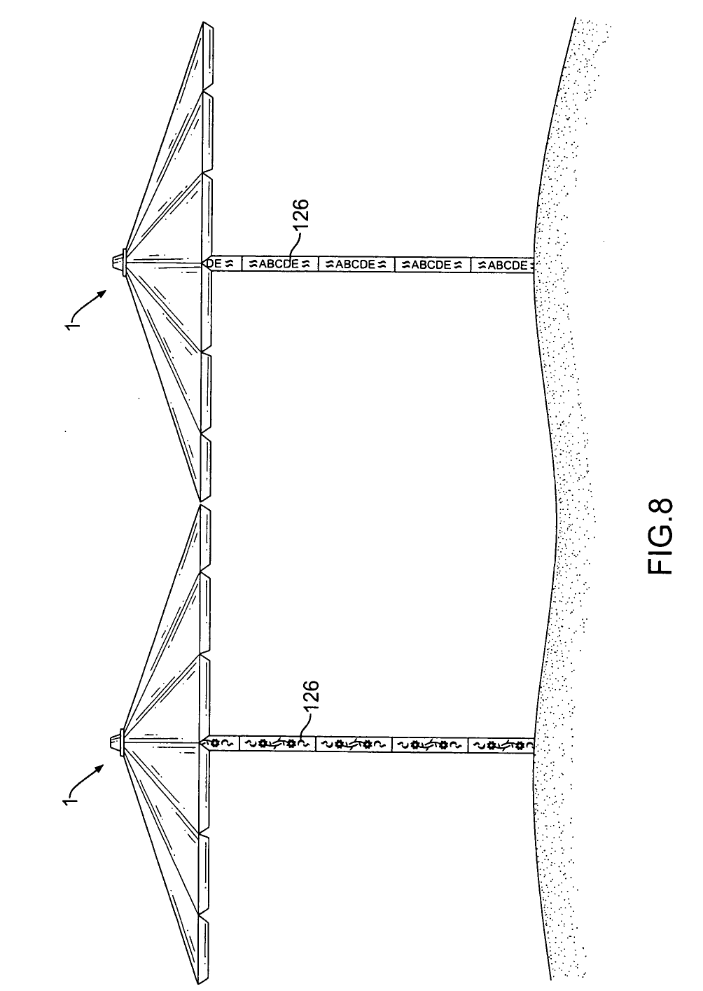

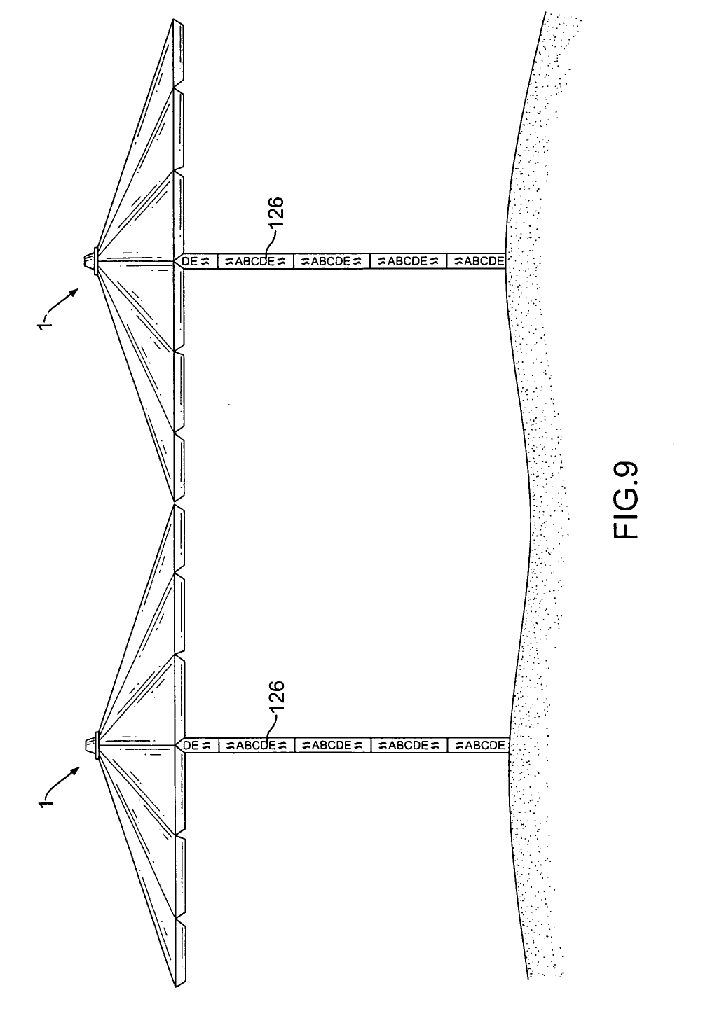

With reference to FIGS. 8 and 9, it is noted that after the first pieces (121) and the second pieces (122) are assembled on and enclose the entire outer periphery of the cylindrical core (11), the pattern (126) of the outer periphery of the first piece (121) and the second piece (122) is able to increase the appearance attraction and uniqueness of the umbrella.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An assembled umbrella shank comprising:
a hollow cylindrical core having multiple holes longitudinally defined in an outer periphery of the cylindrical core;
multiple first pieces each having multiple first hooks formed on opposite sides of the first piece to correspond to and extend into the holes of the cylindrical core; and
multiple second pieces each having multiple second hooks formed on opposite sides of the second piece to correspond to and extend into the holes of the cylindrical core such that after the first pieces and the second pieces are assembled on the outer periphery of the cylindrical core, an annular periphery of the cylindrical core is enclosed.

2. The assembled umbrella shank as claimed in claim 1, wherein each first piece and each second piece respectively have a pattern formed on an outer periphery of the first piece and the second piece.

3. The assembled umbrella shank as claimed in claim 2, wherein the cylindrical core has a pair of opposed recess to correspond to and receive therein a first boss longitudinally formed on an inner face of each of the first pieces and a second boss longitudinally formed on an inner face of each of the second pieces.

4. An assembled umbrella shank comprising:
a hollow cylindrical core;
multiple first pieces each having multiple first hooks formed on a side of the first piece and multiple first recesses defined in a side opposite to the side having the first hooks; and
multiple second pieces each having multiple second hooks formed on a side of the second piece to correspond to and extend into the first recesses of the first piece and multiple second recesses defined in a side opposite to the side having the second hooks and corresponding to and receiving the first hooks therein.

5. The assembled umbrella shank as claimed in claim 4, wherein each first piece and each second piece respectively have a pattern formed on an outer periphery of the first piece and the second piece.

6. The assembled umbrella shank as claimed in claim 5, wherein the cylindrical core has a pair of opposed recesses to correspond to and receive therein a first boss longitudinally formed on an inner face of each of the first pieces and a second boss longitudinally formed on an inner face of each of the second pieces.
